(19) United States
(12) Patent Application Publication
(10) Pub. No.: US 2006/0204628 A1
(43) Pub. Date: Sep. 14, 2006

(54) Bactericidal method

(75) Inventors: Sean T Jones, Tadley (GB); Jeremy P Miller, Mortimer (GB); Neil Hannay, Hindhead (GB)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Air Products Chemicals, Inc, Allentown,, PA (US)

(21) Appl. No.: 10/548,355

(22) PCT Filed: Mar. 9, 2004
(86) PCT No.: PCT/GB04/01009

§ 371 Date: Feb. 23, 2006

(30) Foreign Application Priority Data
Mar. 14, 2003 (GB) 0305920.1

(51) Int. Cl. A23L 1/32; A23L 3/36

(52) U.S. Cl. 426/524; 426/327

(57) ABSTRACT

A method rapidly cools meat by exposure to a rapid cooling temperature of no more than about −10° C. for sufficient time to provide a frozen crust on the meat and chills the resultant crust-frozen meat by exposure of said crust-frozen meat to a chilling temperature greater than the rapid cooling temperature but no more than about +10° C. to raise the temperature of the surface of the meat and to maintain said surface at a temperature no higher than the freezing temperature of the meat for at least sufficient time to injure lethally and/or kill bacteria, thereby reducing the viability of bacteria on meat. The method has particular application in the processing of poultry meat to kill bacteria comprising the Campylobacter and/or Salmonella species. The meat is disinfected in a non-intrusive manner, leaving the meat in as natural a state as possible.

The present invention relates to a method for reducing the viability of bacteria on meat, in particular but not necessarily limited to, poultry meat.

Bacteria, such as the Campylobacter and Salmonella species, represent a significant food hygiene and health issue. It is estimated that the Salmonella species is responsible for between 2 to 4 million cases of food poisoning each year in the US alone. It is also estimated that the Campylobacter species is responsible for even more cases than are caused by Salmonella bacteria. In Europe, the number of cases of food poisoning caused by the Campylobacter species usually far outweighs the number caused by the Salmonella species. For example, in 2001 there were over 56,000 cases of Campylobacter food poisoning reported in England and Wales whereas there were only about 16,000 cases of Salmonella poisoning reported during the same period. The real numbers of actual cases are estimated to be much greater than these numbers due to many cases never being reported. The Food Standards Agency (FSA) in the UK has set a target of reducing food-borne disease by 20% by 2006. Most of this disease can be attributed to Campylobacter bacteria.

Poultry flocks are often infected naturally with Campylobacter bacteria. The poultry industry has been researching ways of eradicating Campylobacter bacteria from the flocks before they arrive at the factory for processing. The results of this research are mixed and, thus, contamination of the birds has not been eradicated nor reliably reduced. Inoculations and new hygiene protocols have successfully eradicated infection by Salmonella bacteria in battery flocks.

It would obviously be preferable to eradicate all unwanted bacterial infection from livestock. However, whilst research into suitable eradication methods continues, there is a need for a reliable method of disinfecting meat, in particular poultry meat, during processing of the meat. A suitable method would be non-intrusive and would leave the meat in a form that is as natural as possible, e.g. the method must not leave any chemical trace or by-products on the carcass and must not spoil the appearance of the meat.

One existing method of disinfecting poultry carcasses involves washing the carcasses with water containing disinfectant(s). However, in Europe, regulations require that potable water must be used to wash poultry carcasses and, thus, disinfectants cannot be present. The prohibition on the use of dissolved disinfectants not only prevents decontamination of carcasses but also prevents continual disinfection of processing equipment and, thus, bacterial transfer and cross-contamination between individual carcasses remains a significant problem in Europe.

One example of a process inhibiting bacterial growth on poultry meat during processing is disclosed in GB-A-2105570 (Ralph; published on 30^{th} Mar. 1983). In this process, eviscerated poultry carcasses are washed to remove contaminants such as intestinal and fecal matter and the washed carcasses “moisturised” in a bath of unrefrigerated water that prechills the carcasses. Surface water is removed from the prechilled carcasses which are then exposed to a super-cold atmosphere at a temperature of about −123° C. produced using streams of cold carbon dioxide gas containing solid carbon dioxide particles. In this way, the surface of each carcass is crust frozen. The carcasses are then allowed to temper by exposure to a temperature between −3.3° C. to 0° C. The primary purpose of the crust-freeze step is to prevent water loss and weepage from the carcasses thereby maintaining the desirable qualities of the meat. However, it is disclosed that any bacterial growth is greatly inhibited thereby improving the shelf life of the product. There is no disclosure of the process having any bactericidal effect.

U.S. Pat. No. 3,637,405 (Mendelson et al; published on 25th Jan. 1972) discloses a process for packaging and preserving meat. In the exemplified embodiment, a line of packaged cut-up or whole chicken is exposed to blasts of cold air at a temperature of −40° C. for about 60 minutes. The resultant packages of crust-frozen chicken meat are then placed in cold storage at about 0° C. for at least 3 hours. It is disclosed that the bacteria growth rate is inhibited but there is no disclosure of the process being bactericidal.

Further crust freezing processes for inhibiting bacterial growth on meat are disclosed in U.S. Pat. No. 4,367,630 (Bernard et al; published on 11th Jan. 1983) and NL-A-9301244 (published on 1^{st} Feb. 1995).

The bactericidal effects of freezing processes have been studied although the results are not very encouraging. For example, the results of studies by Haines (Proceedings of the Royal Society Series B; 1938, 124, pp 451-463) indicate that the temperature or rate of freezing appears to have little effect on the mortality of bacteria within specified limits. In addition, the observations by Gunaratne and Spencer (Poultry Science; 1974, 53, pp 215-220) indicate that freezing does not destroy a significant number of microorganisms on chicken meat. However, freezing processes do appear to have a positive influence on the bactericidal effect of certain substances. For example, the results of studies by Fay and Farias (Applied and Environmental Microbiology; February 1976, pp 153-157) and by Foster and Mead (Journal of Applied Bacteriology; 1976, 41, pp 505-510) indicate that freezing processes improve the bactericidal effects of fatty acids (Fay and Farias) and polyphosphates (Foster and Mead).

Zhao et al have determined rates of Campylobacter jejuni inactivation on poultry exposed to different cooling and freezing temperatures. The results (published in 2000; “Reduction of C. jejuni on the Surface of Poultry by Low-Temperature Treatment”; see www.griffin.peachnet.edu) revealed that a freezing temperature of −20° C. and −30° C. reduced (at 72 h) the population of C. jejuni on chicken wings by 1.3 and 1.8 log₁₀ cfu/g respectively. In addition, results of studies to determine the effect of short time exposure (1 to 120 seconds) of C. jejuni on chicken wings to super low freezing temperature (−80° C. to −196° C.), with the objective of cooling the centre of the wing to −3.3° C., revealed a 0.5 log₁₀ cfu/g reduction of C. jejuni on the surface of the wings at −80° C.; a 0.8 log₁₀ cfu/g reduction at −120° C.; a 0.6-log₁₀ cfu/g reduction at −160° C.; and a 2.4 log₁₀ cfu/g reduction at −196° C. Results revealed that the greatest inactivation occurred when chicken wings are frozen at −196° C. Results further indicate that surface freezing at −80 to −196° C. can retain chicken in a fresh state (inner temperature at −3.3° C.) and significantly reduce surface contamination of C. jejuni.

It is one objective of preferred embodiments of the present invention to provide an improved method of killing bacteria during meat processing without freezing the body of the meat thereby producing a “fresh” meat product.

In a first aspect of the present invention, there is provided use of a method comprising:

rapidly cooling meat by exposure to a rapid cooling temperature of no more than about −10° C. for sufficient time to provide a frozen crust on the meat; and

chilling the resultant crust-frozen meat by exposure of said crust-frozen meat to a chilling temperature greater than the rapid cooling temperature but no more than about +10° C. to raise the temperature of the surface of the meat and to maintain said surface at a temperature no higher than about the freezing temperature of the meat for at least sufficient time to injure lethally and/or kill bacteria,

to reduce the viability of bacteria on meat.

The term “surface temperature” is intended to include both the temperature of the interface between the meat and skin (if present) and the temperature of the exposed outer surface of the meat (if skin is not present). The thickness of the frozen-crust would usually be between from about 0.5 mm to about 4 mm.

Without wishing to be bound by any particular theory, the inventors currently believe that the reduction in the viability of bacteria on meat using the present invention is due to disruption of the integrity of bacterial membranes. Such disruption may be caused by exposure to the rapid cooling temperature itself (e.g. the membrane is damaged or destroyed by the sudden drop in temperature). Alternatively, such disruption may be caused by an increase in osmotic stress on the bacteria. Water in the medium surrounding bacterial cells freezes once the temperature has dropped a sufficient amount. Such freezing has the effect of increasing the concentration of solutes dissolved in the medium which increases the osmotic stress on the cells until the point at which they “burst” once the osmotic stress becomes too great.

One advantage of the present invention is that the risk of bacterial contamination of meat and, thus, infection of the consumer is significantly reduced if the present method is used to reduce the viability of bacteria on meat.

The aim of the method is only to form a frozen crust on the meat and not necessarily to reduce the core temperature. If the meat has skin, then the frozen crust can be formed from the skin. If the meat does not have skin, then the frozen crust will be formed from the surface of the meat. Whilst not essential to the invention, in presently preferred embodiments of the invention, the entire surface of the meat will be crust frozen, including the interior surfaces of carcasses where applicable.

The rapid cooling temperature is usually between from about −50° C. to about −10° C., preferably between from about −40° C. to about −20° C. and is more preferably about −35° C. The meat is usually exposed to the rapid cooling temperature for between from about 5 minutes to about 1 hour, preferably between from about 10 minutes to about 30 minutes and more preferably for about 25 minutes or about 20 minutes. In general, the lower the rapid cooling temperature, the shorter the exposure time required to freeze the surface of the meat.

The temperature at which meat freezes depends on a number of factors including the composition of the meat (primarily its water content) and, thus, on the type of the meat, where it comes from on the animal, e.g. which muscle group, and on the state of the animal. It is, therefore, difficult to assign a meaningful single figure to the freezing temperature of meat. Typically, meat freezes at a temperature between from about −5° C. to 0° C. Generally, the meat industry takes the freezing temperature of meat to be between from about −2° C. to about −0.5° C. and the freezing temperature of chicken meat to be between from about −2° C. to about −1° C. Chicken breast meat usually freezes at about −1.8° C. The freezing temperature of beef is usually about −1.1° C.

The chilling temperature is usually between from about −15° C. to about +10° C., e.g. from about −10° C. to about +10° C., preferably between from about −15° C. to about 0° C., e.g. −10° C. to about 0° C., and more preferably is about −5° C. or about −10° C. The resultant crust-frozen meat is usually exposed to the chilling temperature for between from about 30 minutes to about 3 hours, preferably between from about 30 minutes to about 2 hours and more preferably for about 50 minutes or about 70 minutes.

In preferred embodiments, the meat is exposed to the rapid cooling temperature and the chilling temperature for no more than about 3 hours in total.

In preferred embodiments, after the chilling step, the resultant chilled meat is tempered by exposure to a tempering temperature of between from about +5° C. to about +30° C. The tempering temperature is preferably from about +10° C. to about +20° C. and, more preferably, about +15° C. The chilled meat may be exposed to the tempering temperature for between from about 0 to about 60 minutes, preferably from about 10 to about 40 minutes and, more preferably, for about 30 minutes. In such embodiments, the meat is exposed to the rapid cooling temperature, the chilling temperature and the tempering temperature for no more than about 3 hours in total.

In preferred embodiments, the method further comprises storing the resultant chilled meat or the resultant tempered meat (depending whether the tempering step is present) at a refrigeration temperature above the freezing temperature to reduce and/or control bacterial contamination of stored meat over an initial storage period of between from about 1 day to about 7 days.

In a preferred embodiment, poultry carcasses are cooled rapidly by exposure to a rapid cooling temperature of about −35° C. for about 25 minutes. The resultant crust frozen carcasses are then chilled by exposure to a chilling temperature of about −5° C. for about 50 minutes. The resultant chilled carcasses are then tempered by exposure to a tempering temperature of about +15° C. for about 30 minutes.

In another embodiment, poultry carcasses are cooled rapidly by exposure to a rapid cooling temperature of about −35° C. for about 20 minutes. The resultant crust frozen carcasses are then chilled by exposure to a chilling temperature of about −10° C. for about 70 minutes. The resultant chilled carcasses may then be tempered by exposure to a tempering temperature of about +15° C. for about 30 minutes.

The disinfected meat would usually be stored at a refrigeration temperature, e.g. between from about +2° C. to about +6° C., either directly after the chilling step (in embodiments of without a tempering step) or after the tempering step.

The invention has application in the bactericidal treatment of any meat, for example, poultry, beef, pork, lamb and fish. However, the invention has particular application in the processing poultry meat on the carcass of a dressed freshly slaughtered unboned poultry bird. The term “poultry” is used herein to include any domestic fowl, for example, chickens, ducks, geese and turkeys, or game or wild fowl, for example, grouse, guinea fowl, pigeons, partridges, pheasants and quails. However, the invention has particular application to factory farmed poultry, especially chickens or turkeys.

Whilst it would be possible to process a single poultry bird, the process would preferably be mechanised for processing continuous lines of meat, e.g. poultry birds. In preferred embodiments, the invention would be applied to an existing meat processing line. If means for rapidly cooling the meat were required, a rapid cooler would preferably be retrofitted to an existing chiller.

The meat may be rapidly cooled by any suitable means including using sprays of liquid cryogen such as liquid nitrogen or liquid carbon dioxide. However, in preferred embodiments, the meat is rapidly cooled by mechanical refrigeration. Similarly, the resultant crust-frozen meat may be chilled by any suitable means although mechanical refrigeration is preferred. In one embodiment, the meat is rapidly chilled using jets of cold gas, e.g. air. Poultry carcasses may be chilled by exposure of the outside only or chilled both inside and outside using such jets.

The invention has particular application in the removal of gram negative bacteria, for example, Campylobacter and/or Salmonella species.

The method may further comprise pre-chilling the meat before exposure to the rapid cooling temperature. The pre-chilling step may be carried out by exposure of the meat to a pre-chilling temperature of about −5° C. Alternatively, the method may not comprise actively pre-chilling the meat prior to exposure to the rapid cooling temperature. In the case of disinfecting poultry carcasses, after the birds have been slaughtered, defeathered and eviscerated, they are usually washed with cold water just prior to cooling rapidly. The purpose of the wash is to clean the birds and not to pre-chill the body of the meat on the carcasses. The temperature of the deep muscle of the bird may be between from about +30° C. to about +40° C. immediately prior to exposure to the rapid cooling temperature if the meat is not pre-chilled or may be less than +30° C. if the meat is pre-chilled.

In a second aspect of the present invention, there is provided a method for reducing the viability of bacteria on meat, said method comprising:

rapidly cooling meat by exposure to a rapid cooling temperature of between from about −40° C. to about −20° C. for between from about 10 minutes to about 30 minutes to provide a frozen crust on the meat; and

chilling the resultant crust-frozen meat by exposure of said crust-frozen meat to a chilling temperature between from about −15° C. to about +10° C. to raise the temperature of the surface of the meat and to maintain said surface at a temperature no higher than the freezing temperature of the meat for between from about 30 minutes to about 3 hours to injure lethally and/or kill bacteria.

In preferred embodiments, the method has any appropriate combination of method features discussed above.

The following is a description, by way of example only and with reference to the accompanying drawings, of presently preferred embodiments of the invention. In the drawings:

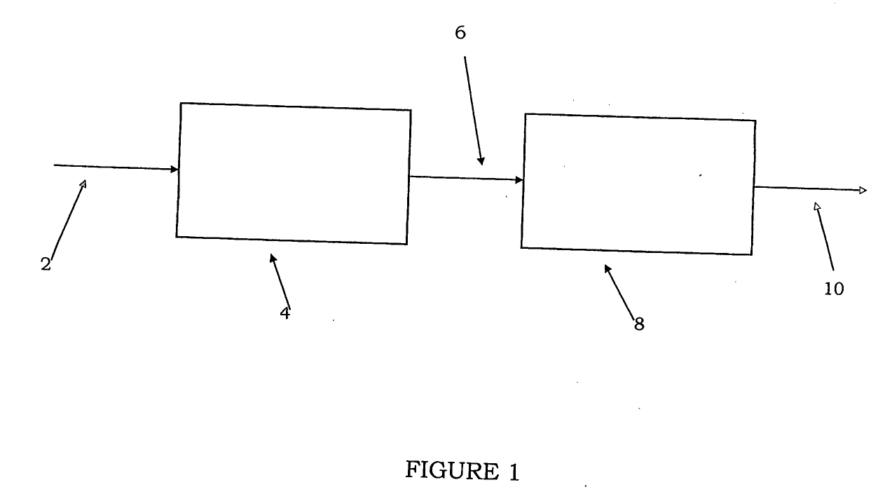

FIG. 1 is a flow diagram depicting an embodiment of the present invention;

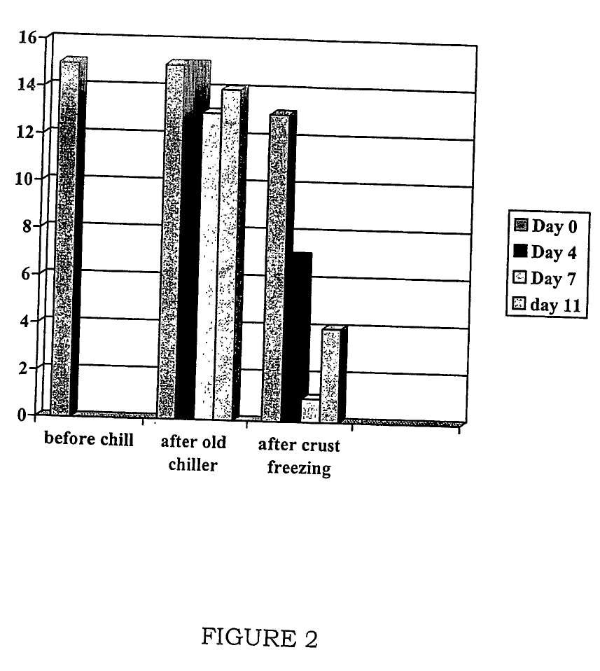

FIG. 2 is a bar chart depicting the results from Example 1;

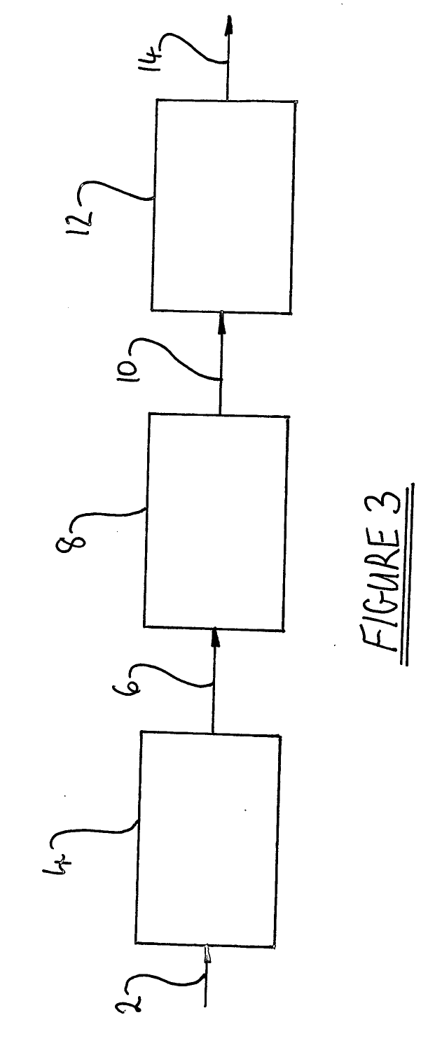

FIG. 3 is a flow diagram depicting another embodiment of the present invention; and

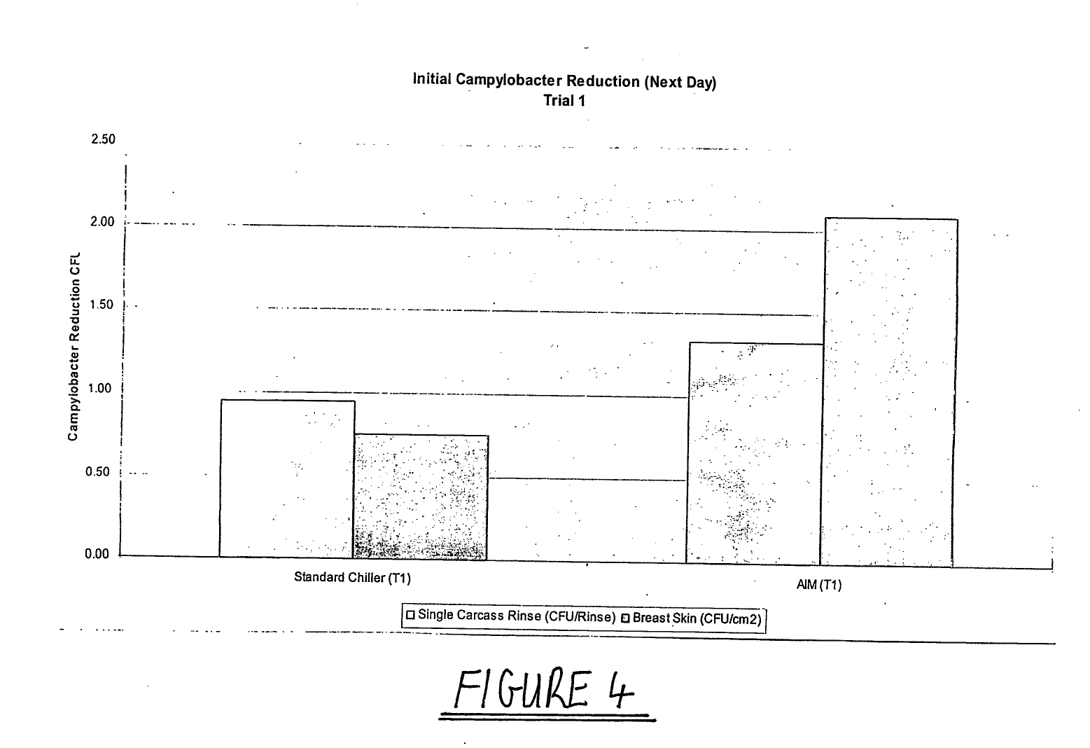

FIG. 4 is a bar chart depicting results from Example 2;

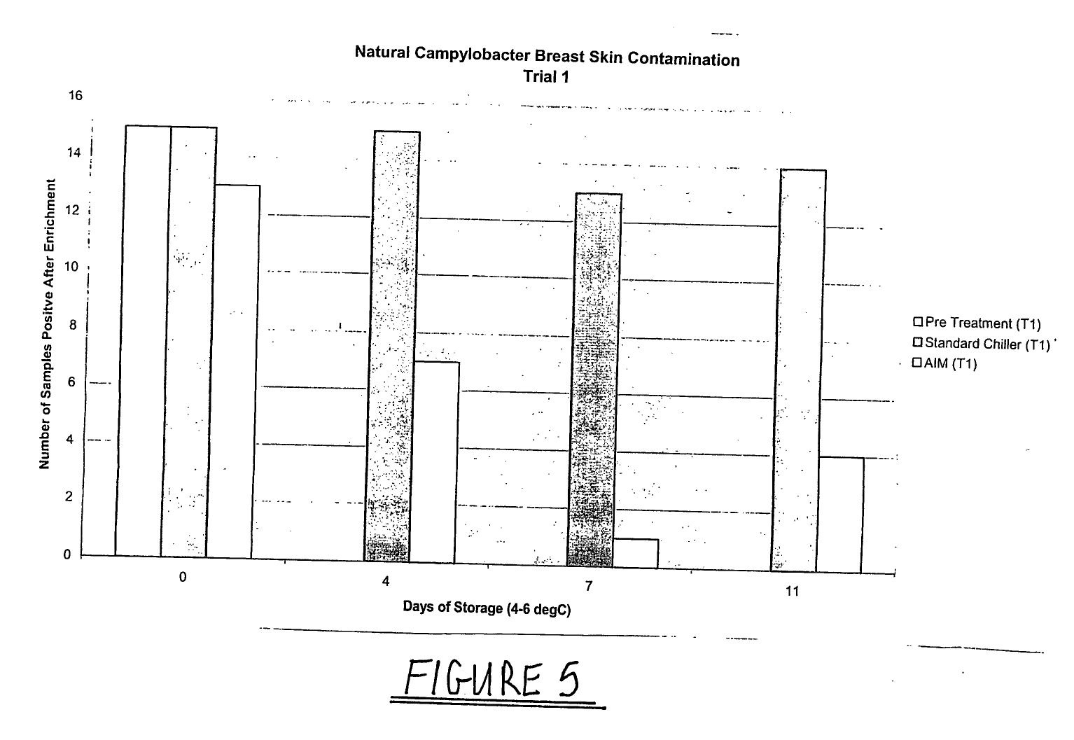

FIG. 5 is also a bar chart depicting results from Example 2;

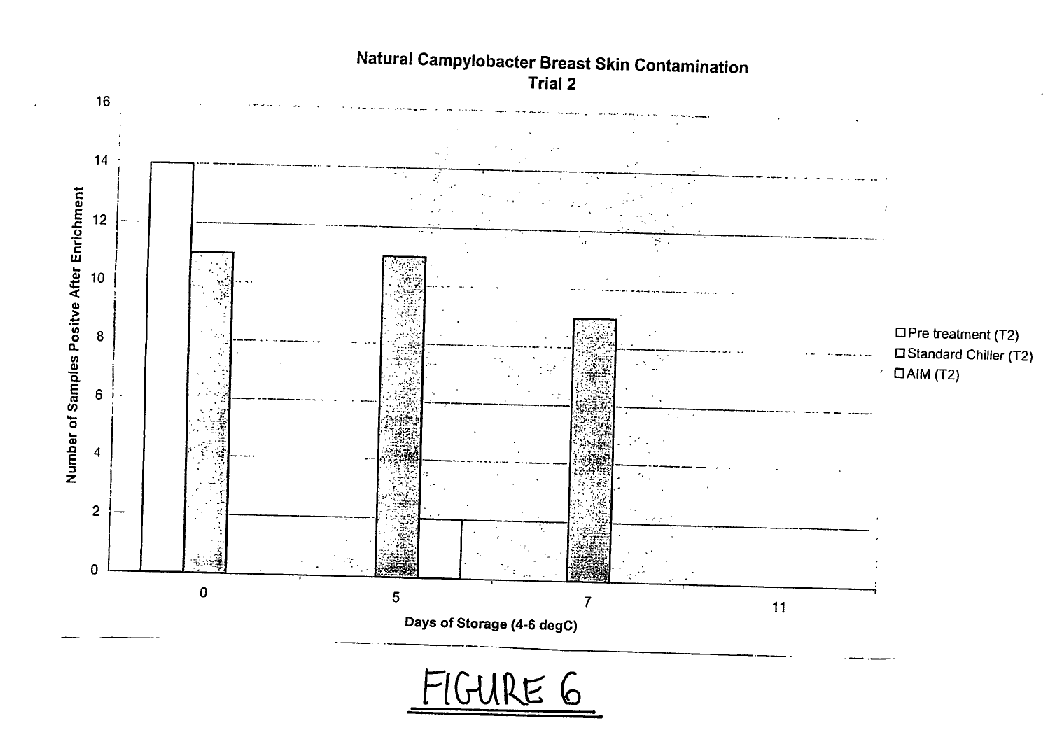

FIG. 6 is another bar chart depicting results from Example 2; and

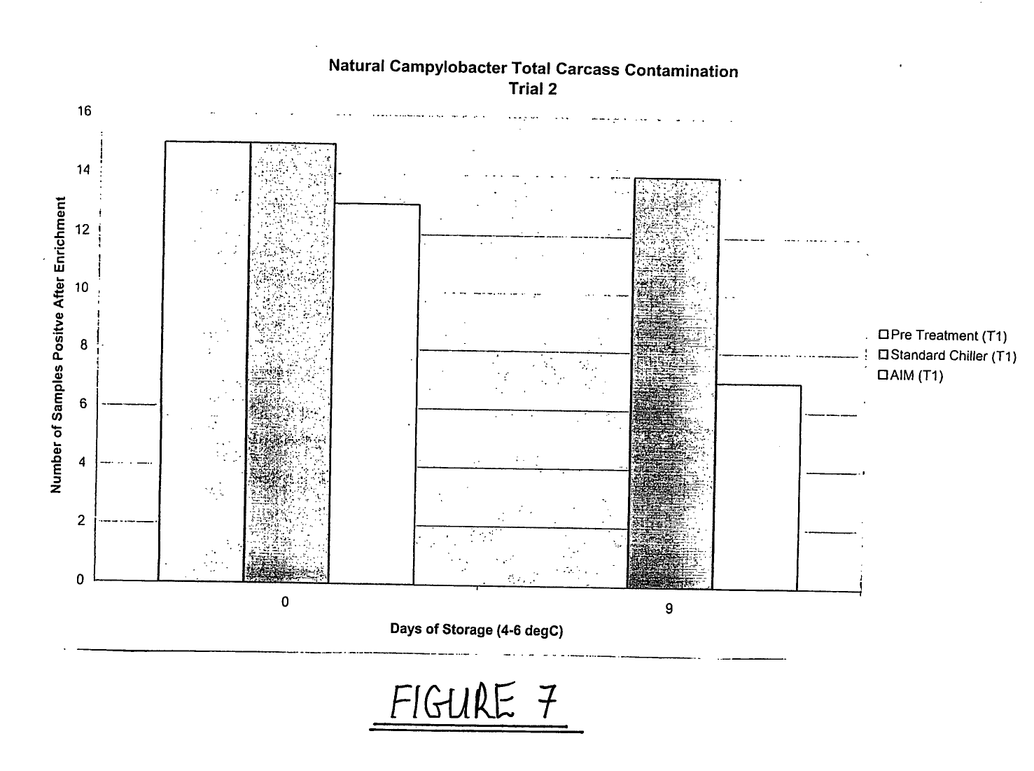

FIG. 7 is a further bar chart depicting results from Example 2.

Referring to FIG. 1, dressed, freshly slaughtered chicken carcasses are fed via line 2 to a first mechanical refrigerator 4 in which they are exposed to a rapid cooling temperature of −35° C. for 20 minutes. The carcasses are cooled rapidly using jets (not shown) of cold gas, e.g. air. The entire surface of each carcass is crust-frozen. The crust frozen carcasses are removed from the first mechanical refrigerator 4 and are fed via line 6 to a second mechanical refrigerator 8 in which they are chilled by exposure to a chilling temperature of −5° C. for 50 minutes. The surface temperature of each carcass is raised to about the freezing temperature of chicken meat, i.e. −1.8° C. or −2° C., and is then maintained at that temperature to reduce the viability of bacteria on the meat. The chilled carcasses are removed from the second mechanical refrigerator 8 via line 10 and subjected to further processing and/or refrigerated storage.

Referring to FIG. 3, dressed, freshly slaughtered chicken carcasses are fed via line 2 to a first mechanical refrigerator 4 in which they are exposed to a rapid cooling temperature of −35° C. for 25 minutes. The carcasses are cooled rapidly using jets (not shown) of cold gas, e.g. air. The entire surface of each carcass is crust-frozen. The crust frozen carcasses are removed from the first mechanical refrigerator 4 and are fed via line 6 to a second mechanical refrigerator 8 in which they are chilled by exposure to a chilling temperature of −10° C. for 70 minutes. The surface temperature of each carcass is raised to about the freezing temperature of chicken meat, i.e. −1.8° C. or −2° C., and is then maintained at that temperature to reduce the viability of bacteria on the meat. The chilled carcasses are removed from the second mechanical refrigerator 8 via line 10 and fed to a tempering zone 12 where there are exposed to a tempering temperature of +15° C. for 30 minutes. Tempered birds are removed from the tempering zone 12 via line 14.

### EXAMPLE 1

Material and Methods

Naturally Contaminated Carcasses

A flock of free-range broilers, known to be positive for Campylobacter and scheduled for slaughter second in the day, were targeted. After approximately 25% of the flock had been processed (e.g. slaughtered, plucked, eviscerated and washed), 45 carcasses were removed from the line immediately after the inside/outside washer and immediately before the chiller. The following 30 carcasses were marked and allowed to proceed through the chiller (“old chiller”) for 1 h 50 mins, being chilled counter-currently at −5° C. on exit from the chiller. These were then removed from the line after chilling.

Experimental Chiller

15 of the 45 carcasses were examined immediately by the whole carcass rinse technique, 15 were sent through the new chiller (as described in FIG. 1) and examined by carcass rinse after chilling, 15 were sampled immediately, by excision of 10 cm² of breast skin, passed through the chiller and re-examined by breast skin excision after chilling.

Old Chiller

The 30 marked carcasses were removed from the line immediately after chilling. 15 were sampled by excision of 10 cm² of breast skin and 15 by carcass rinse.

Inoculated Carcasses

Another 15 carcasses from the flock being processed were removed from the line immediately after the inside/outside washer and immediately before the chiller. They were inoculated on the breast with a mixture of Campylobacter jejuni and Escherichia coli K12 (non-pathogenic strains), allowed to remain at ambient temperature for at least 15 minutes and then each sampled by excision of 10 cm² of breast skin, before being passed through the experimental chiller. As soon as they emerged from the chiller, they were sampled again in the same way.

Inoculation

A strain of C. jejuni (AR6, isolated from a poultry carcass by Prof. D. Newell, VLA, Weybridge, Surrey, UK) was incubated in nutrient broth (Oxoid CM1) with growth supplement Oxoid SR84E at 37° C. for 48 h in microaerobic atmosphere. A nalidixic acid resistant strain of E. coli K12 was incubated in heart infusion (Difco) for 24 h at 37° C. The cultures were transported to the factory at 2±0.5° C. and stored at the same temperature overnight until used the following day. Equal volumes of the two cultures were mixed immediately before use. 1 ml of the mixture was dispensed over the breast of each carcass using a pipette and spreading with a bent plastic rod.

Packing, Transportation and Shelf-Life Trial

The carcasses examined by carcass rinse were discarded. The carcasses (naturally contaminated and inocluated) examined by excision of breast skin were packed immediately after chilling and sampling in individual polythene bags, labelled and loaded on to trays into a refrigerator, maintained at 2±0.5° C. Transportation from the factory to the laboratory was at the same temperature. They arrived on day 1 (slaughter on day 0). The carcasses were stored in the laboratory at 1±0.5° C. for 1 day, left at ambient temperature (ca. 20° C.) for 2 h, then stored at 6±1° C. until day 11. Repeat sampling of breast skin was carried out after 4, 7 and 11 days.

Microbial Examination

Skin Samples

Areas of breast skin of 10 cm² were excised from each carcass using sterile aluminium templates and sterile scalpels, forceps and scalpel blades. The skin samples were packed in individual sterile plastic bags and stored at 2±0.5° C. during transportation and until examination in the laboratory.

Carcass Rinse

The carcasses were placed individually into large sterile plastic bags, 300 ml of sterile chilled MRD (maximum recovery diluent, Oxoid CM 733) were poured on to the carcass and, holding the bag tightly around the legs of the carcass, the bag was shaken in various directions for a total of approximately 1 minute, so that all parts of the carcass were rinsed. The rinse fluid was decanted into sterile bottles and stored at 2±0.5° C. during transportation and until examination in the laboratory.

Microbial Testing of Skin and Carcass Rinse Fluid

The breast skin samples were treated in a stomacher with 10 ml sterile MRD.

Quantitative Examination

Decimal dilutions were prepared of the supernatant from the skin samples and the carcass rinse fluid, and surface colony counts carried out for Campylobacter ssp. at 37° C. for 48 h in microaerobic atmosphere (CCDA medium, Oxoid CM 739 and SR155) and for E. coli on McConkey agar at 37° C. for 24 h (Oxoid CM 7 with 100 ppm nalidxiic acid—inoculated skin only). Each dilution was plated in duplicate. Suspect Campylobacter colonies were checked by o-xidase reaction, Gram stain and using a latex agglutination kit (Oxoid DR 150).

Presence/Absence of Campylobacter ssp

The skin that remained after stomaching was added to 25 ml of Exeter enrichment broth (Oxoid CM 983 with growth supplement Oxoid SR 84E and selective supplement Mast SV59 (mg/l) trimethoprim 10; rifampicin 5; polymyxin B 2500iu; cefoperazone 15; amphotericin B2 and 1% lysed horse blood). Carcass rinse samples were enriched in a similar way, by adding approximately about 5 ml of carcass rinse to 22 ml of Exeter enrichment broth. Incubation was aerobic with tightly closed lid and 1-2 cm head space at 37° C. for 48 h. The broth cultures were streaked out on to CCDA (see above) and incubated at 37° C. for 48 h in microaerobic atmosphere. Suspect colonies were checked as above.

Recording of Results and Statistical Analysis

Log₁₀ numbers of colony forming units (CFU) of the various groups of microbes per cm² (breast skin) or per ml (carcass rinse) were compared between carcasses pre-chill and post-chill, and between carcasses chilled in the old or new chiller on day 0 as well as during shelf-life. This was done using one-way analysis of variance (Minitab) when there were sufficient enumeration results. Presence/absence results (number of samples out of 15 positive) on Campylobacter were compared using Fisher's exact test.

### Results and Discussion

The results are summarised in Table 1. In the results, when numbers of campylobacter were below the limit of detection by direct plating, the results of enrichment/plating are given (No. of samples out of 15 positive).

TABLE 1
mean (range) (n = 15) log₁₀ colony forming units (cfu) per ml
carcass rinse or per cm² breast skin

| | Campylobacter | — |
|---|---|---|
| Carcass rinse | | — |
| before chill | 3.3 (2.6-3.7) | |
| after old chiller | 2.36 (1.4-3.6) | — |
| after new chiller | 1.98 (0.4-2.8) | — |
| Difference in mean log | 0.36 | — |
| count between chillers | | |
| Naturally contaminated | | |
| breast skin | | |
| Day 0 | | |
| before chill | 2.59 (2.0-3.2) 15/15* | — |
| after old chiller | 1.84 (1.1-2.7) 15/15* | — |
| after new chiller | 0.74 (<0.4-1.0) 13/15* | — |
| Difference in mean log | 1.10 | — |
| count between chillers | | |
| Day 4 | | |
| old chiller | 15/15* | — |
| new chiller | 7/15* | — |
| Day 7 | | |
| old chiller | 13/15* | — |
| new chiller | 1/15* | — |
| Day 11 | | |
| old chiller | 14/15* | — |
| new chiller | 4/15* | — |
| Inoculated breast skin | Campylobacter | Escherichia coli |
| before chill | 3.26 (2.5-3.5) | 4.31 (3.7-4.6) |
| after new chiller | 2.22 (1.7-2.5) | 3.22 (<2.7-4.0) |
| Day 4 | <1.7-2.5 | 3.02 (<2.7-3.6) |
| Day 7 | (15/15)* | 2.30 (<1.7-2.9) |
| Day 11 | (14/15)* | 2.79 (1.7-3.6) |

*number out of 15 positive after enrichment

Carcass Rinse

Numbers of all the groups of microbes examined were lower after than before chilling by either method (p<0.01). The reduction in numbers of Campylobacters after chilling was highly significant whichever chiller was used (p>0.001). Numbers of Campylobacter were lower after new chiller than after old chiller but this was not statistically significant (p>0.05).

Breast Skin—Day 0

Naturally Contaminated Carcasses

The numbers of Campylobacter were reduced by both methods (p<0.001), but were lower after the new chiller than after the old chiller (p>0.001).

Inoculated Carcasses

Numbers of the inoculated Campylobacter were reduced after the new chiller (p<0.00 1). The effect of the old chiller was not investigated.

Breast Skin—Day 4-11

Naturally Contaminated Carcasses

Numbers of Campylobacter were mostly too low to be enumerated by plate count but comparison of numbers out of 15 positive by enrichment showed that there were significantly fewer on the skin from new chiller carcasses on all three sampling occasions (p<0.01) and that numbers fell during chill storage.

Inoculated Carcasses

As with the naturally contaminated carcasses, there was evidence that numbers of Campylobacters fell during chilled storage. The proportion of positive carcasses by day 11 was higher than on the naturally contaminated carcasses, reflecting the higher initial numbers. Numbers of E. coli declined slightly. This may have been expected, since 6° C. is at the lower limit for multiplication of E. coli.

### EXAMPLE 2

Eviscerated chicken carcasses were processed according to the process depicted in FIG. 3. Accordingly, carcasses were cooled rapidly by exposure to a temperature of −35° C. for 25 minutes. The resultant crust frozen carcasses were then chilled at −10° C. for 70 minutes and the resultant chilled carcasses were tempered at +15° C. for 30 minutes. For comparative purposes, different eviscerated chicken carcasses were chilled at about −5° C. for about 2 hours in a standard chiller. Samples of carcasses chilled according to the invention and according to the standard chilling method were then analysed for Campylobacter infection as described in Example 1. Two Experimental Analyses were carried out. In Experimental Analysis 1, Campylobacter loadings of 6 log₁₀ per carcass rinse and 2.6 log₁₀/cm² of breast skin were seen. In Experimental Analysis 2, Campylobacter loadings of <4 log₁₀ per carcass rinse and <1.7 log₁₀/cm² of breast skin were seen. The results are indicated in FIGS. 4 to 7. Unchilled eviscerated chicken carcasses were also analysed for Campylobacter infection and the results used as a control.

In Experimental Analysis 1, the Campylobacter counts pre-chilling were all measurable. Post-chilling, the counts were not measurable for skin samples. In Experimental Analysis 2, the Campylobacter counts pre-chilling were not measurable for nearly all samples.

As shown in FIG. 4, the initial Campylobacter reduction (next day) is significantly higher for the process of the present invention when compared to the standard chiller, when measured by both the single carcass rinse and breast skin methods. FIGS. 5 and 6 depict the numbers of carcass samples positive for Campylobacter contamination (on breast skin) after enrichment after having been stored at +4° C. to +6° C. for 0, 4, 7 and 11 and for 0, 5, 7 and 11 days respectively. FIG. 7 depicts the numbers of carcass samples positive for Campylobacter contamination (on the total carcass) after enrichment after having been stored at +4° C. to +6° C. for 0 and 9 days. The results shown in FIGS. 5 to 7 clearly indicate a significant reduction in Campylobacter contamination over time when the method of the present invention rather than the standard chilling process is used to chill poultry.

### SUMMARY AND CONCLUSIONS

This study compared the effect of chilling, using two different methods, on the microbiology of groups of 15 chicken carcasses treated in parallel. Numbers of Campylobacters were determined on breast skin before and after chilling and during shelf-life on naturally contaminated carcasses and carcasses inoculated with Campylobacters and Escherichia coli. Naturally contaminated carcasses were also examined by whole carcass rinse for Campylobacters before and after chilling but not during shelf life.

Numbers of Campylobacter and E. coli were reduced after chilling using either the new of the old chiller and examining either naturally-occurring or inoculated organisms. Mean numbers were lower after the new chiller than after the old chiller. The difference was highly significant when breast skin was examined, but the reduction was not statistically significant when naturally contaminated carcasses were examined by whole carcass rinse. This may have been because the breast skin reached a lower temperature during chilling than other parts of the carcass, especially the body cavity.

Numbers of inoculated and naturally occurring Campylobacters declined during chilled storage after chilling in either the new chiller of the old chiller. Numbers of Campylobacters on the breast skin remained significantly lower on the carcasses from the new chiller than the old chiller at all test times. By the end of the shelf-life (days 7 and 11), 5/30 naturally contaminated samples from the new chiller were positive for Campylobacter as were 27/30 samples from the old chiller.

The reduction in numbers of inoculated E. coli after the new chiller (not tested in the old chiller) indicates that the new chiller might also reduce numbers of Salmonellae, if present.

The method of the present invention significantly increases the rate of dying off of Campylobacter during normal shelf storage. The likelihood of breast meat being contaminated by the time it reaches the consumer is significantly reduced and may even be zero. Results indicate complete eradication of Campylobacter in poultry contaminated to a lower degree (<5×10¹ CFU/cm² skin). Therefore, poultry that becomes Campylobacter positive through contaminated processing equipment could effectively be free of Campylobacter after chilling using the present invention. An initial 2 log₁₀ reduction in contamination with a reduction by <10% in detectable contamination has been observed in heavily contaminated poultry (>10³ CFU/cm² skin) at the end of shelf life. The breast of free range poultry has been shown to be between 92% 100% less likely to have Campylobacter near the end of its shelf life. In addition, free range poultry has been shown to be 50% less likely to have detectable Campylobacter from the whole carcass by the end of its shelf life.

Throughout the specification, the term “means” in the context of means for carrying out a function, is intended to refer to at least one device adapted and/or constricted to carry out that function.

It will be appreciated that the invention is not restricted to the details described above with reference to the preferred embodiments but that numerous modifications and variations can be made without departing from the spirit or scope of the invention as defined by the following claims.

1. Use of a method comprising:
rapidly cooling meat by exposure to a rapid cooling temperature of no more than about −10° C. for sufficient time to provide a frozen crust on the meat; and
chilling the resultant crust-frozen meat by exposure of said crust-frozen meat to a chilling temperature greater than the rapid cooling temperature but no more than about +10° C. to raise the temperature of the surface of the meat and to maintain said surface at a temperature no higher than the freezing temperature of the meat for at least sufficient time to injure lethally and/or kill bacteria, to reduce the viability of bacteria on meat.

2. Use as claimed in claim 1 wherein the rapid cooling temperature is between from about −50° C. to about −10° C.

3. Use as claimed in claim 1 wherein the meat is exposed to the rapid cooling temperature for between from about 5 minutes to about 1 hour.

4-7. (canceled)

8. Use as claimed in claim 1 wherein the meat is chicken meat having a freezing temperature of between from about −2° C. to about −1° C.

9. Use as claimed in claim 1 wherein the chilling temperature is between from about −15° C. to about +10° C.

10. Use as claimed in claim 1 wherein the resultant crust-frozen meat is exposed to the chilling temperature for between from about 30 minutes to about 3 hours.

11-14. (canceled)

15. Use as claimed in claim 1 wherein the resultant chilled meat is tempered by exposure to a tempering temperature of between from about +5° C. to about +30° C.

16. Use as claimed in claim 7 wherein the resultant chilled meat is exposed to the tempering temperature for between from about 0 to about 60 minutes.

17-20. (canceled)

21. Use as claimed in claim 1 wherein the meat is exposed to the rapid cooling temperature, the chilling temperature and the tempering temperature for no more than about 3 hours in total.

22. Use as claimed in claim 1 wherein the method further comprises storing the resultant chilled meat or the resultant tempered meat at a refrigeration temperature above the freezing temperature to control bacterial contamination of stored meat over an initial storage period of between from about 1 day to about 7 days.

23. Use as claimed in claim 1 wherein the meat is poultry meat.

24. Use as claimed in claim 1 wherein the bacteria comprise at least one species selected from the group consisting of Campylobacter and Salmonella.

25. Use as claimed in claim 1 wherein the method does not comprise actively pre-chilling the meat prior to exposure to the rapid cooling temperature.

26. Use as claimed in claim 1 wherein the method further comprises pre-chilling the meat prior to exposure to the rapid cooling temperature.

27. (canceled)

28. A method for reducing the viability of bacteria on meat, said method comprising:
rapidly cooling meat by exposure to a rapid cooling temperature of between from about −40° C. to about −20° C. for between from about 10 minutes to about 30 minutes to provide a frozen crust on the meat; and
chilling the resultant crust-frozen meat by exposure of said crust-frozen meat to a chilling temperature between from about −15° C. to about +10° C. to raise the temperature of the surface of the meat and to maintain said surface at a temperature no higher than the freezing temperature of the meat for between from about 30 minutes to about 3 hours to injure lethally and/or kill bacteria.

29. (canceled)
